(19) United States
(12) Patent Application Publication
(10) Pub. No.: US 2004/0175110 A1
(43) Pub. Date: Sep. 9, 2004

(54) Method and apparatus for recording/reproducing signals on magnetic tape

(76) Inventors: Hideaki Kosaka, Tokyo (JP); Tetsuro Shida, Tokyo (JP)

Correspondence Address: BIRCH STEWART KOLASCH & BIRCH, PO BOX 747, FALLS CHURCH, VA, 22040-0747, US

(21) Appl. No.: 10/286,886

(22) Filed: Nov. 4, 2002

(30) Foreign Application Priority Data
Feb. 28, 2002 (JP) 2002-052955

(51) Int. Cl. H04N 5/783; G11B 5/09

(52) U.S. Cl. 386/68; 386/83; 386/95

(57) ABSTRACT

A method for recording signals on a magnetic tape including receiving an input signal, extracting a program-linked signal from the input signal, modulating the program-linked signal so as to have a frequency different from any frequency within a predetermined possible range of a control signal, recording the input signal on a recording track, and recording the control signal and the modulated program-linked signal on the control track. A method for reproducing signals recorded on the magnetic tape including reading a compound signal including the control signal and the modulated program-linked signal from the control track, separating the modulated program-linked signal from the CTL signal, and outputting a video signal based on the separated modulated program-linked signal.

### BACKGROUND OF THE INVENTION

1. Field of the Invention

The present invention relates to a method for recording/reproducing signals on a magnetic tape, which can be applied to an apparatus such as a D-VHS VCR (Data Video Home System Video Cassette Recorder), an apparatus that implements the aforementioned method, and a magnetic tape, on which the program-linked information is recorded through the use of the aforementioned method. In particular, the present invention relates to a method for recording/reproducing signals on a magnetic tape, by which the program-linked information can be displayed even when the magnetic tape is running in a high speed running mode such as a fast forward or rewind mode wherein signals on the recording track (i.e., video track) are not reproduced.

2. Description of the Related Art

In a magnetic recording/reproducing apparatus such as a D-VHS VCR that records digital broadcast signals on the magnetic tape, the MPEG data containing the program-linked information are recorded on the recording track of the magnetic tape, and the control signal indicating a running speed of the magnetic tape is recorded on the control track of the magnetic tape.

Accordingly, in a tape running mode (e.g., a fast forward mode, a fast rewind mode, or an index search mode based on the VISS (VHS Index Search System) or the like) wherein the MPEG data recorded on the recording track are not reproduced, it is impossible to know the program-linked information contained in the MPEG data. In other words, it is impossible to know which program recorded on the magnetic tape is passing in front of the record/reproduce head and which part in a specific program recorded on the magnetic tape is passing in front of the record/reproduce head.

Further, there is a system wherein the high-speed picture search data are recorded on the recording track so that the searched picture is displayed by reading the high-speed picture search data in the fast forward or rewind mode. However, when fast forwarding or rewinding operation is carried out while the record/reproduce head reads the high-speed picture search data recorded on the recording track, the running speed of the magnetic tape cannot be made too fast.

### SUMMARY OF THE INVENTION

It is an object of the present invention to provide a method for recording/reproducing signals on a magnetic tape that makes it possible to display the program-linked information not only in the normal playback mode but also in the tape running mode without the reproduction of the video signal, an apparatus that implements the aforementioned method, and a magnetic tape, on which the program-linked information is recorded through the use of the aforementioned method.

According to one aspect of the present invention, a method for recording signals on a magnetic tape, includes receiving an input signal containing program data and program-linked information associated with the program data; extracting a program-linked signal containing the program-linked information from the input signal; modulating the program-linked signal so as to have a frequency different from any frequency within a predetermined possible range of a control signal, a frequency of the control signal being within a predetermined range corresponding to a running speed of the magnetic tape; recording the input signal on a recording track of the magnetic tape; and recording the control signal and the modulated program-linked signal on a control track of the magnetic tape.

According to another aspect of the present invention, a magnetic tape includes a recording track, on which an input signal containing program data and program-linked information associated with the program data is recorded; and a control track, on which both a control signal of a frequency within a predetermined range corresponding to a running speed of the magnetic tape and a modulated program-linked signal are recorded. The modulated program-linked signal is obtained by extracting a program-linked signal containing the program-linked information from the input signal and modulating the program-linked signal so as to have a frequency different from any frequency within a predetermined possible range of the control signal.

According to a further aspect of the present invention, a method for reproducing signals recorded on a magnetic tape includes reading a compound signal including the control signal and the modulated program-linked signal from the control track of the magnetic tape; separating the modulated program-linked signal from the control signal; and outputting a video signal based on the separated modulated program-linked signal.

According to a further aspect of the present invention, an apparatus for recording signals on a magnetic tape, includes a record head which records an input signal containing program data and program-linked information associated with the program data on a recording track of the magnetic tape; a program information extractor which extracts a program-linked signal containing the program-linked information from the input signal; a modulator which modulates the program-linked signal so as to have a frequency different from any frequency within a predetermined possible range of a control signal, a frequency of the control signal being within a predetermined range corresponding to a running speed of the magnetic tape; and a control head which records the control signal and the modulated program-linked signal on a control track of the magnetic tape.

According to a further aspect of the present invention, an apparatus for reproducing signals recorded on a magnetic tape includes a reproduce head which reads the input signal recorded on the recording track of the magnetic tape; a control head which reads a compound signal including the control signal and the modulated program-linked signal from the control track of the magnetic tape; a circuit which separates the modulated program-linked signal from the control signal; and a signal output section which outputs a video signal based on the separated modulated program-linked signal.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram schematically showing a magnetic recording/reproducing apparatus according to a first embodiment of the present invention and devices connected thereto;

FIG. 2 is a schematic diagram showing an arrangement of the magnetic recording/reproducing apparatus according to the first embodiment;

FIG. 3 is an explanatory diagram schematically showing recording tracks, a control track and an audio track of a magnetic tape, on which data are recorded by the magnetic recording/reproducing apparatus according to the first embodiment;

FIG. 4 is a conceptual diagram showing recording operation to the magnetic tape by the magnetic recording/reproducing apparatus according to the first embodiment;

FIG. 5 is a block diagram schematically showing a magnetic recording/reproducing apparatus according to a second or third embodiment of the present invention and devices connected thereto;

FIG. 6 is a schematic diagram showing an arrangement of the magnetic recording/reproducing apparatus according to the second embodiment; and

FIG. 7 is a schematic diagram showing an arrangement of the magnetic recording/reproducing apparatus according to the third embodiment.

### DETAILED DESCRIPTION OF THE INVENTION

Further scope of applicability of the present invention will become apparent from the detailed description given hereinafter. However, it should be understood that the detailed description and specific examples, while indicating preferred embodiments of the invention, are given by way of illustration only, since various changes and modifications will become apparent to those skilled in the art from the detailed description.

First Embodiment

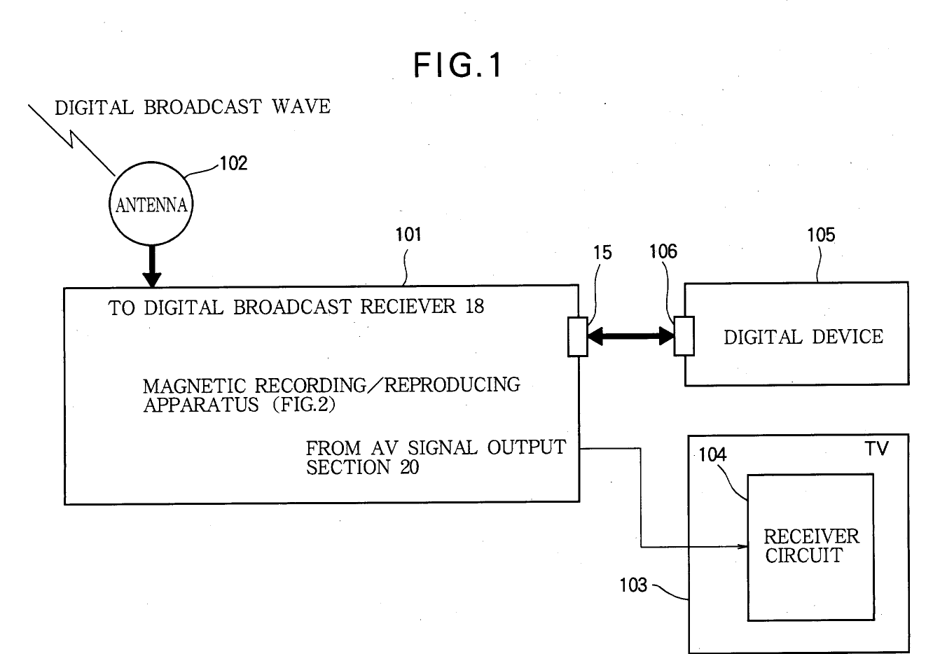

FIG. 1 is a block diagram schematically showing a magnetic recording/reproducing apparatus 101 (i.e., an apparatus that implements a method for recording and/or reproducing signals on a magnetic tape) according to the first embodiment of the present invention and devices connected thereto. Referring to FIG. 1, an antenna 102 for receiving the digital broadcast wave (bit stream data) is connected by an antenna cable to the magnetic recording/reproducing apparatus 101. Further, an analog video output of the magnetic recording/reproducing apparatus 101 is transmitted to a receiver circuit 104 of a television (TV) set 103. Furthermore, a serial interface (e.g., an IEEE (Institute of Electrical and Electronics Engineers) 1394 interface) 15 of the magnetic recording/reproducing apparatus 101 is connected by an exclusive cable to a serial interface (e.g., an IEEE 1394 interface) 106 of a digital device 105 such as another D-VHS VCR or a hard disk recorder.

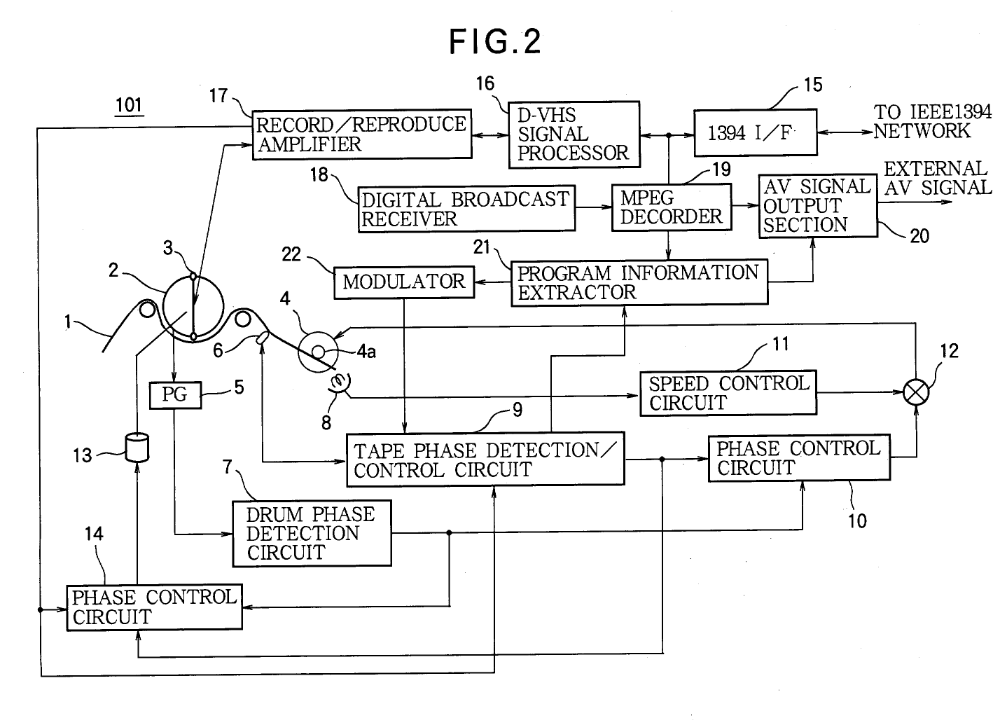

FIG. 2 is a schematic diagram showing an arrangement of the magnetic recording/reproducing apparatus 101 according to the first embodiment of the present invention. Referring to FIG. 2, the magnetic recording/reproducing apparatus 101 is, for example, a D-VHS VCR. The magnetic recording/reproducing apparatus 101 records an input signal on a magnetic tape 1 through the use of a magnetic head or heads (i.e., a record/reproduce head or heads) 3 mounted on a rotary drum 2 on a helical scan basis. The magnetic recording/reproducing apparatus 101 also records a control signal (CTL signal) indicating a running speed of the magnetic tape 1 on a control track (CTL track) of the magnetic tape 1 through the use of a control head (CTL head) 6.

Further, the present invention can be applied to another device such as a VHS VCR of an analog recording system, wherein the video data is recorded on the recording track (usually, positioned in a central part of the magnetic tape in its width direction) and a CTL signal having a frequency corresponding to a running speed of the magnetic tape is recorded on the CTL track (usually, positioned at one end of the magnetic tape in its width direction). Furthermore, although the magnetic recording/reproducing apparatus 101 having both recording and reproducing functions is illustrated in FIG. 2, a magnetic recording apparatus for implementing a magnetic recording method of the present invention and a magnetic reproducing apparatus for implementing a magnetic reproducing method of the present invention may be provided respectively independently. Moreover, a magnetic tape having a CTL track, on which a modulated program-linked signal is recorded by the magnetic recording method to be explained later, is also included in the present invention.

Referring to FIG. 2, the magnetic recording/reproducing apparatus 101 includes a capstan motor 4 for rotating a capstan 4a that runs the magnetic tape 1 at a constant speed, and a phase generator (PG) 5 that generates a pulse signal (PG signal) whenever a predetermined rotary position of the rotary drum 2 passes a predetermined detecting position in order to identify a current position of the magnetic head 3 mounted on the rotary drum 2. Further, the magnetic recording/reproducing apparatus 101 includes the CTL head 6 that records the CTL signal indicating a start point position (i.e., a tape phase) of the recording track on the control track of the magnetic tape 1 (at one end in its width direction) and reproduces the CTL signal therefrom. Furthermore, the magnetic recording/reproducing apparatus 101 includes a drum phase detection circuit 7 that detects a specific position on the rotary drum 2 on the basis of the PG signal, thereby detecting a rotary phase (i.e., a drum phase) of the rotary drum 2, a frequency generator (FG) 8 that generates a signal (i.e., a capstan FG signal) indicating a rotational speed of the capstan 4a, and a tape phase detection/control circuit 9 that detects a tape phase on the basis of the CTL signal.

Referring to FIG. 2, the magnetic recording/reproducing apparatus 101 includes a phase control circuit 10 that adjusts the magnetic tape phase with respect to the drum phase in such a manner that the recording track is located at a suitable position on the magnetic tape 1, and a speed control circuit 11 that controls a running speed of the magnetic tape 1 on the basis of the capstan FG signal in such a manner that the magnetic tape 1 runs at a constant speed. Further, the magnetic recording/reproducing apparatus 101 includes a signal adder 12 that adds an output of the phase control circuit 10 and an output of the speed control circuit 11, thereby generating a speed control signal for keeping the rotational speed of the capstan motor 4 such a constant speed that the recording track can be located at a suitable position with respect to the position of the magnetic head 3 on the rotary drum 2. Furthermore, the magnetic recording/reproducing apparatus 101 includes a motor drive 13 that drives the rotary drum 2 in accordance with an output of a phase control circuit 14. In the record mode, the phase control circuit 14 receives a reference signal such as a synchronizing signal of a video signal and adjusts the motor drive 13 in such a manner that the drum phase is synchronized with an output timing of the video signal to be recorded.

Referring to FIG. 2, the magnetic recording/reproducing apparatus 101 includes an IEEE 1394 interface 15 that is connected to an external device in accordance with the IEEE 1394 Interface Standard. Further, the magnetic recording/reproducing apparatus 101 includes a D-VHS signal processor 16 that, in the record mode, receives the MPEG data or the like through the IEEE 1394 interface 15, arranges the received data into a data structure based on the D-VHS Standards, adds an error correction code to the structure, converts the structure into a recording signal, and outputs the recording signal. The D-VHS signal processor 16, in the playback mode, subjects the reproduced signal to error correction, extracts the MPEG stream from the reproduced signal, and then outputs the extracted stream.

Referring to FIG. 2, the magnetic recording/reproducing apparatus 101 includes a record/reproduce amplifier 17 that subjects the recording signal received from the D-VHS signal processor 16 to waveform equalization and amplification, thereby generating the signal to be recorded. The record/reproduce amplifier 17, in the playback mode, subjects the reproduced signal to waveform equalization, phase compensation and so on, thereby removing waveform distortion inherent in the magnetic medium from the reproduced signal. Further, the magnetic recording/reproducing apparatus 101 includes a digital broadcast receiver 18 that tunes the broadcast wave signal received at the antenna and subjecting the turned signal to digital demodulation to extract the MPEG data therefrom, an MPEG decoder 19 that decodes the MPEG data extracted by the digital broadcast receiver 18 to output an analog video/audio signal, and an AV signal output section 20 that outputs the video/audio signal decoded by the MPEG decoder 19 to the external devices.

Referring to FIG. 2, the magnetic recording/reproducing apparatus 101 includes a program information extractor 21 that, in the record mode, extracts a program-linked signal containing the program-linked information from the input signal to be recorded. The program information extractor 21, in the tape running mode such as the playback mode, a fast forward mode or a fast rewind mode, acquires the modulated program-linked signal that has been reproduced by the CTL head 6 and transmitted through the tape phase detection/control circuit 9, and inputs an analog video signal for the text display to an AV signal output section 20 to be explained later.

Referring to FIG. 2, the magnetic recording/reproducing apparatus 101 includes a modulator 22 that modulates the program-linked signal so as to have a frequency different from (for instance, higher than) any frequency within a predetermined possible range of the CTL signal, a frequency of which is within a predetermined range corresponding to a running speed of the magnetic tape 1. The tape phase detection/control circuit 9, in the record mode, receives the modulated program-linked signal, adds it to the CTL signal to generate the compound signal, and inputs the compound signal to the CTL head 6. The tape phase detection/control circuit 9, in the tape running mode such as the playback mode and the fast forward or rewind mode, separates the modulated program-linked signal from the control signal reproduced by the CTL head 6 and transmits the modulated program-linked signal to the program information extractor 21.

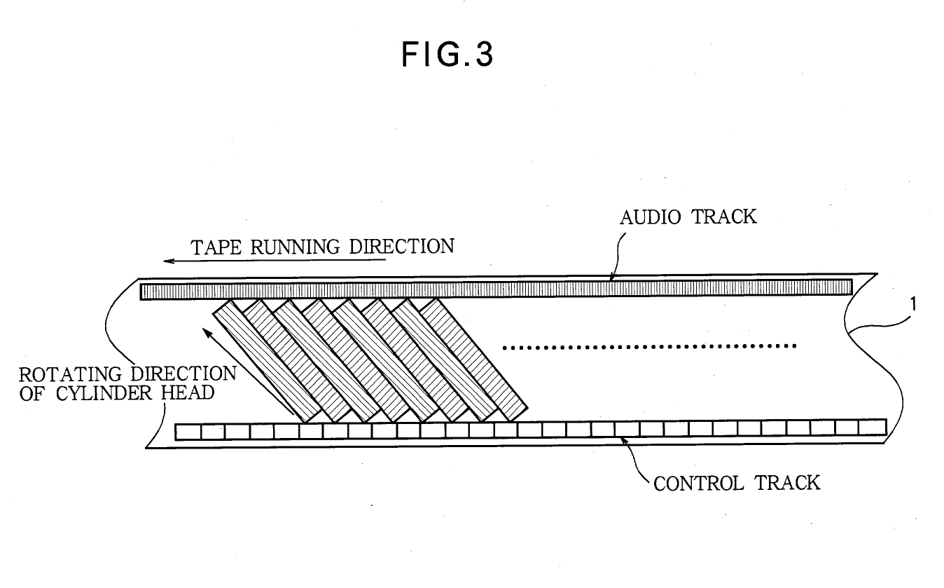

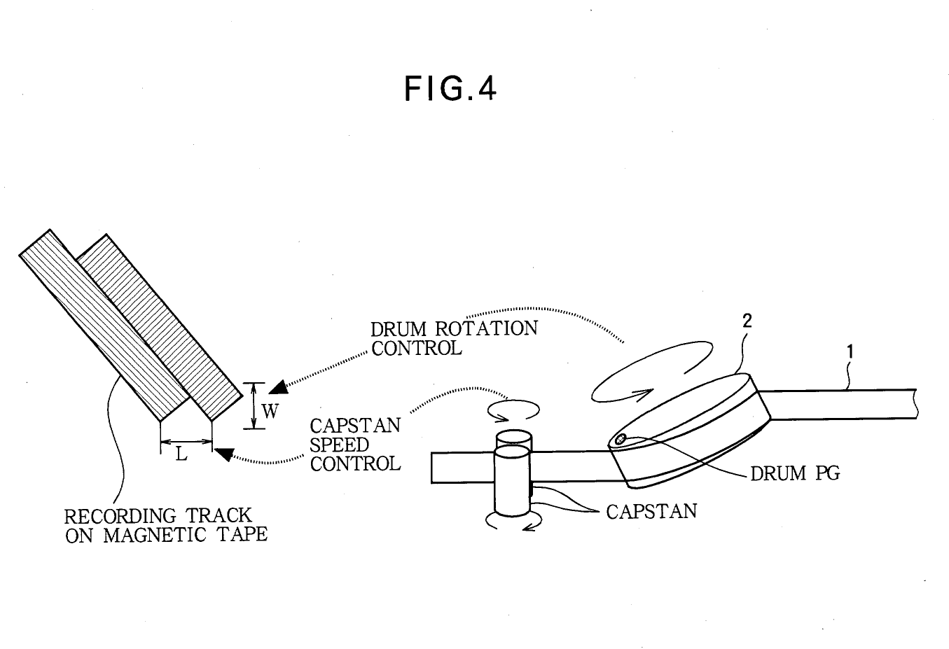

FIG. 3 is an explanatory diagram schematically showing recording tracks, a CTL track and an audio track of the magnetic tape 1, on which data are recorded by the magnetic recording/reproducing apparatus 101 according to the first embodiment. Further, FIG. 4 is a conceptual diagram showing the recording operation to the magnetic tape through the use of the magnetic recording/reproducing apparatus according to the first embodiment.

Referring to FIG. 3, a track, which is extended in a magnetic tape running direction (in a leftward direction in FIG. 3) in the vicinity of one end (an upper end in FIG. 3) of the magnetic tape 1 in its width direction, is an audio track for recording audio signals. A track, which is extended in the magnetic tape running direction in the vicinity of the other end (a lower end in FIG. 3) of the magnetic tape 1 in its width direction, is a CTL track for recording the CTL signal for controlling the tape running speed and the modulated program-linked signal. Referring to FIG. 3, a plurality of tracks (hatched areas), which are extended in an oblique direction in a central part of the magnetic tape in its width direction, are the recording tracks for recording therein an analog video signal or digital data in the digital record mode. In general, a record/reproduce head or heads (a magnetic head or heads 3 in FIG. 2) scans the magnetic tape 1 in a direction directed from the CTL track side toward the audio track side (that is, from the bottom toward left-side obliquely upwards in FIG. 3) for sequential recording or playback.

An explanation will next be made as to the operation of the magnetic recording/reproducing apparatus 101 when receiving and recording the digital broadcast signal. The magnetic recording/reproducing apparatus 101 not only can perform the digital recording operation to record the MPEG data on the magnetic tape but also can perform the analog recording operation. In the following description, only the digital recording operation will be described.

Referring to FIG. 1, the digital broadcast signal is received at the digital broadcast receiver 18 of the magnetic recording/reproducing apparatus 101 via the antenna 102. In the digital broadcast receiver 18 shown in FIG. 2, the tuning of the broadcast wave signal, the digital demodulation and decoding of the error correction code at the time of transmission are carried out to extract the MPEG data. The extracted MPEG data are input to the MPEG decoder 19 to be subjected to the video/audio decoding operation. The decoded video and audio signals passed through the AV signal output section 20 and are transmitted to an external device such as a TV set for TV viewers.

In the record mode, the MPEG decoder 19 outputs the MPEG data to the D-VHS signal processor 16. The D-VHS signal processor 16 constructs the MPEG data into a data block based on the D-VHS Standard, adds an error correction code to the block, and input the block to a record/reproduce amplifier 17 as the data to be recorded on the magnetic tape. The record/reproduce amplifier 17 performs the wave form shaping operation to the data to be recorded in order to obtain a signal suitable for magnetic recording, and outputs the signal to be recorded to the magnetic head 3.

The analog audio signal, the video signal or MPEG data, and the CTL signal are recorded on the tracks of the magnetic tape 1 as shown in FIG. 3. Of tracks for recording these signals the recording tracks (i.e., main tracks) for recording the video signal or MPEG data on the helical scan basis by the magnetic head 3 of the rotary drum 2 are required to be controlled so that the intervals (L in FIG. 4) between the recording tracks are constant and each recording track has a start point position at an identical height (W in FIG. 4) in the width direction of the magnetic tape 1. As shown in FIG. 4, such positional control over the recording tracks is carried out by adjusting the rotational speed of the capstan for causing the magnetic tape 1 to run and the rotational speed of the rotary drum 2 for causing the magnetic heads 3 to scan along the magnetic tape 1. In FIG. 4, for example, when the rotational speed of the capstan is decreased, the track interval becomes narrower; whereas, when the capstan speed is increased, the track interval becomes wider. By adjusting the rotational speed of the rotary drum 2, the timing of the magnetic head 3 to be contacted with the magnetic tape 1 is adjusted and the adjustment of the recording tracks to have the same height in the width direction of the magnetic tape 1 is also carried out.

The rotary drum 2 is arranged to rotate at a constant rotational speed. The PG 5 generates a PG signal on the basis of the pulse which is generated whenever the rotary drum 2 rotates by one turn, and sends it to the drum phase detection circuit 7. The drum phase detection circuit 7 converts the PG signal into a drum phase signal indicating a momentary position of the magnetic head 3 on the rotary drum 2, and sends the drum phase signal to the phase control circuit 10 and the phase control circuit 14.

The magnetic recording/reproducing apparatus employing the helical scan recording scheme is controlled so that the synchronizing signal in the video signal in the analog record mode or a header signal indicating a head of the recording data block in the digital record mode is recorded at a start point position on the recording tracks. To this end, the phase control circuit 14 controls the phase of the rotary drum 2 on the basis of the synchronizing signal received from the record/reproduce amplifier 17 and the PG signal received from the PG 5 in such a manner that the magnetic head 3 reaches the start point position of the recording track according to the output timing of the recording signal. As a result, as shown in FIG. 4, the recording of the video signal on the magnetic tape 1 is started with the start point position of the recording track in the vicinity of one end (in the vicinity of the CTL track) in the width direction of the magnetic tape 1.

At this time, the capstan motor 4 is controlled so that the tape running speed is kept at a constant value and the recording tracks are continuously arranged with a predetermined interval therebetween. To this end, the speed information indicating a rotational speed of the capstan motor 4 detected by the FG 8 is sent to the speed control circuit 11. The speed control circuit 11 outputs a signal to keep the tape running speed at a constant level. The signal from the speed control circuit 11 is transmitted via the signal adder 12 to the capstan motor 4. The tape phase detection/control circuit 9 generates, in the record mode, a CTL signal synchronized with the synchronizing signal received from the record/reproduce amplifier 17 and applies the CTL signal to the CTL head 6, thereby recording the CTL signal on the CTL track of the magnetic tape 1 shown in FIG. 3. Since the CTL signal is generated based on the synchronizing signal, the CTL signal is a signal corresponding to the magnetic tape phase indicating the position of the recording track of the magnetic tape 1.

Further, in the record mode, the program information extractor 21 searches the MPEG data for the program-linked information contained therein through the MPEG decoder 19 or independently and acquires the program-linked information. The program-linked information including an event number, a program start time and a program length is usually stored in a data table conformed and determined by the broadcast standard and transmitted from each broadcasting system which encodes the MPEG data. To this end, the program information extractor 21 previously holds the storage position of the data table based on the broadcast standard and then performs the data searching operation. In the case of the BS digital broadcast in Japan, for example, “event_id” as an event number item, “start_time” as a program start time item and “duration” as a program length item are described in an EIT (Event Information Table) detectable by a predetermined Packet Identification Number (PID or packet ID). The program-linked information including the event number, the program start time and the program length can be acquired based on the above items. When the MPEG data encoded by another recording apparatus is input via the IEEE 1394 interface 15 for its recording, there is a possibility that a data table based on the broadcast standard may not be present in the MPEG data. In such a case, after the program information extractor 21 searches for the data table and confirmed a failure of finding the corresponding data table, a record start time or date (based on a signal from a date/time output circuit, which is not shown) is obtained and used as the program-linked information.

The program-linked information acquired by the program information extractor 21 is sorted into a program name, a program start time, a program length, a program summary, a broadcast channel number of the program, a recording start date and so on, which are then reconstructed into predetermined data formats and applied to the modulator 22. The modulator 22 receives and modulates the program-linked signal containing the program-linked information with a frequency (higher than the frequency range of the CTL signal, for example) different from the frequency range of the CTL signal and applies the modulated program-linked signal to the tape phase detection/control circuit 9. The frequency of the modulation wave is sufficiently higher than the frequency used in the VISS function generally known as a high-speed index search function. Since the frequency of the CTL signal is 30 Hz and the frequency components of the VISS index signal are in a range of about 50 Hz to 100 Hz, a modulation frequency to be used in the modulator 22 is practically 300 Hz or more. These frequencies are, in the fast forward, fast rewind or index search mode, increased proportionally with the tape running speed. For example, in the tape rewind mode of 500-time speed, the CTL signal has a frequency of 15 kHz (=30 Hz×500), the VISS index signal has a frequency of 50 kHz (=100 Hz×500), and the modulation signal has a frequency of 150 kHz (=300 Hz×500) or more, as signal components.

Further, the program information extractor 21 intermittently monitors the data table of the program-linked information and, when detecting the change of the program-linked information, updates the program-linked information. In the absence of the updated program-linked information, the modulator 22 repetitively modulates the same program-linked information. In the absence of the data table, the program information extractor 21 does not update the program-linked information including the recording start time or date, and the modulator 22 repetitively modulates and outputs information about the record start time or date until the recording is completed.

An explanation will next be made as to the operation of the magnetic recording/reproducing apparatus 101 when the magnetic tape 1 is running (including the playback mode). In FIG. 2, the signal recorded on the magnetic tape 1 is reproduced by the magnetic head 3 mounted to the rotary drum 2 and the reproduced signal is applied to the record/reproduce amplifier 17. At this time, an FG signal having a period corresponding to the rotational speed of the capstan is output from the FG 8 and input to the speed control circuit 11. The speed control circuit 11 compares the period of the FG signal with a target period, generates and outputs a signal to the signal adder 12 to keep the tape running speed at a constant value and to accurately scan the recording tracks recorded with the predetermined interval.

The drum phase detection circuit 7 receives the PG signal from the PG 5 which generates a pulse in accordance with the rotation of the rotary drum 2, detects the phase of the rotary drum 2 on the basis of the received PG signal, and inputs a drum phase control signal to the phase control circuit 10 and the phase control circuit 14. Further, the tape phase detection/control circuit 9 detects a tape phase on the basis of the CTL signal recorded on the CTL track of the magnetic tape 1 and reproduced by the CTL head 6, and outputs the CTL signal to the phase control circuit 10.

The phase control circuit 10 compares the input phase (drum phase) of the rotary drum 2 with the phase (tape phase) of the magnetic tape 1, and adjusts a control voltage value in such a manner that the magnetic head 3 can scan the recording track of the magnetic tape 1 from a suitable track start end. An output of the phase control circuit 10 is added at the signal adder 12 to an output of the speed control circuit 11 for the phase control of the capstan, whereby the magnetic head 3 can scan the recording tracks.

The record/reproduce amplifier 17 receives a reproduction signal reproduced by the magnetic head 3 therefrom, subjects the reproduction signal to the signal processing operations such as the phase compensation and the wave equalization, and then inputs it to the D-VHS signal processor 16. The D-VHS signal processor 16 performs the error correcting operation based on the D-VHS Standard over the received signal, extracts the MPEG data therefrom, and then inputs the extracted MPEG data to the MPEG decoder 19 and the IEEE 1394 interface 15. The IEEE 1394 interface 15 converts the MPEG data into packets on the basis of the IEEE1394 Standard, and outputs the packets to an external IEEE 1394 connection device (such as the digital device 105 in FIG. 1). The MPEG decoder 19 decodes the audio/video data on the basis of service information extracted from the received MPEG data to generate a video/audio signal, and then outputs the video/audio signal to an external analog device (e.g., the TV set 103 in FIG. 1) via the AV signal output section 20.

The program-linked signal that was superposed to the CTL signal in the record mode is reproduced by the CTL head 6 and applied to the tape phase detection/control circuit 9. The tape phase detection/control circuit 9 detects a tape phase from the CTL signal. The tape phase detection/control circuit 9 separates the program-linked signal from the CTL signal through a high pass filter (HPF) which separates only frequency components higher than a specific frequency range from the input signal or through a band pass filter (BPF) which separates only signal components in a specific frequency range from the input signal.

The program-linked signal separated by the tape phase detection/control circuit 9 is applied to the program information extractor 21. The program information extractor 21 sorts the received program-linked information into a program name, a broadcast start time, a broadcast time, a recording start date and the like or extracts individual program-linked information such as a recording start time and/or date and the like therefrom, converts the program-linked information to video signals arranged at specific positions on the display screen, and then inputs them to the AV signal output section 20. The AV signal output section 20 superposes the video signals received from the tape phase detection/control circuit 9 on a video signal obtained by decoding the MPEG data received from the MPEG decoder 19, and presents it to the viewer.

Further, the AV signal output section 20, even when failing to receive the video signal from the MPEG decoder 19, outputs only the video signal generated based on the program-linked information, thereby continuing to offer the program-linked information to the viewer.

As mentioned above, the magnetic recording/reproducing apparatus 101 according to the first embodiment can, in the record mode, acquire the program-linked signal, modulate the program-linked signal, and superpose the modulated program-linked signal on the CTL signal, record the compound signal on the CTL track, and, in the tape running mode, separates the modulated program-linked signal from the CTL signal and display the information based on the modulated program-linked signal. For this reason, in the magnetic recording/reproducing apparatus 101 (or in the recording and/or reproducing method employed in the apparatus), the program-linked information can be offered to the viewer not only in the normal playback mode but also in the tape running mode such as a fast forward mode, a fast rewind mode or the VISS mode regardless of the reproduction of the video signal.

Second Embodiment

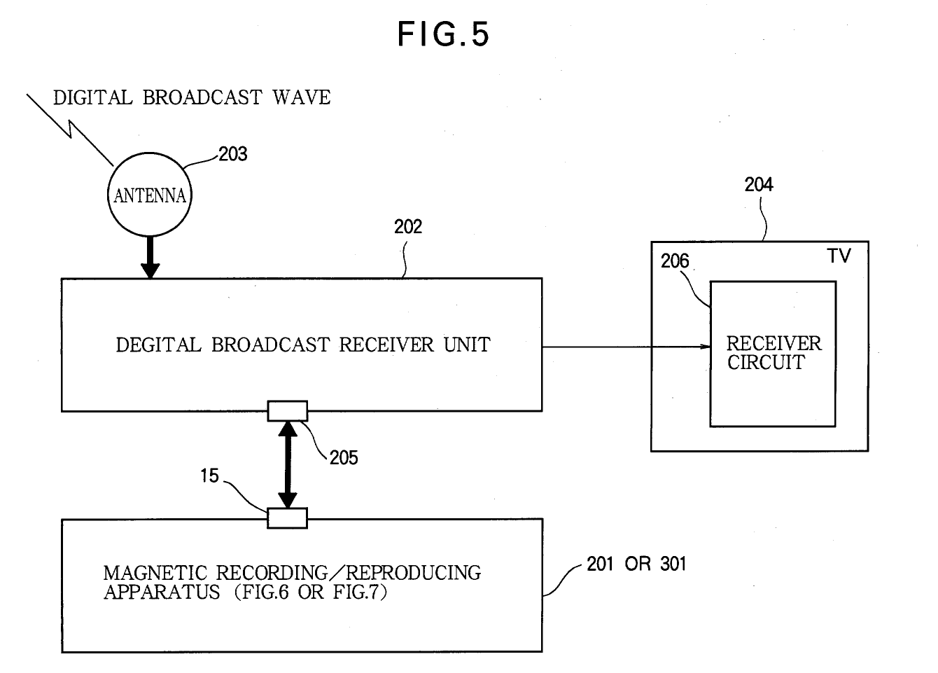

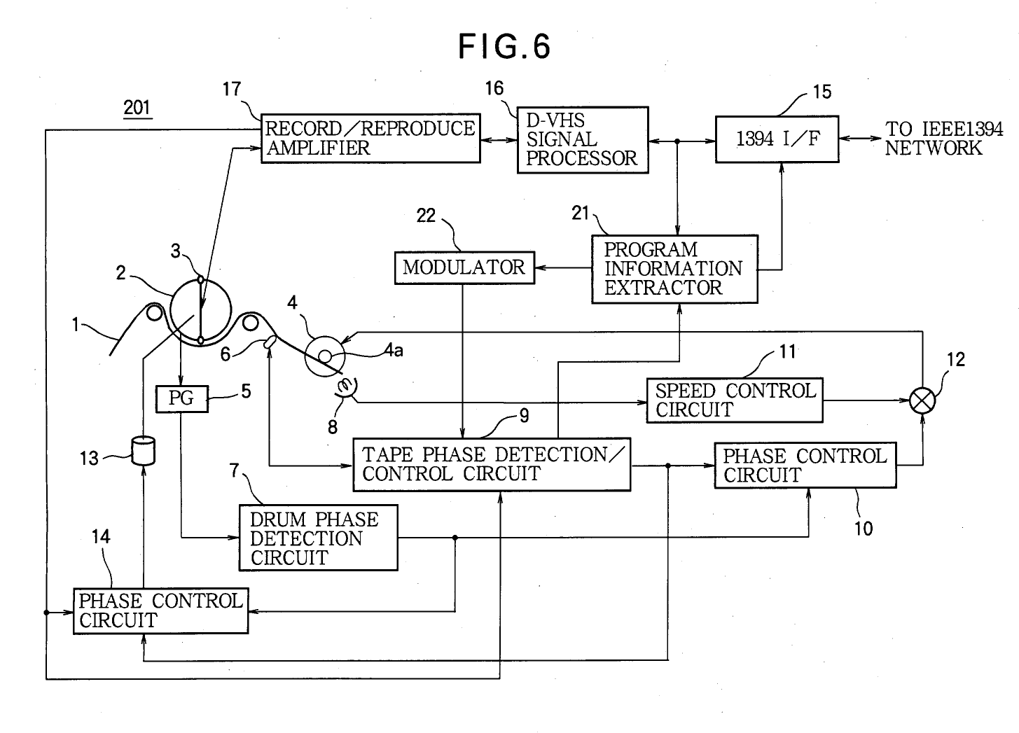

FIG. 5 is a block diagram schematically showing a magnetic recording/reproducing apparatus 201 (i.e., an apparatus that implements a method for recording and/or reproducing signals on a magnetic tape) according to the second embodiment of the present invention and devices connected thereto. Further, FIG. 6 is a schematic diagram showing an arrangement of the magnetic recording/reproducing apparatus 201 of FIG. 5. Components in FIG. 6 that are the same as or correspond to components in FIG. 2 are denoted by the same reference numerals. Furthermore, in the description of the second embodiment, reference will be made to FIGS. 3 and 4 that are used in the description of the aforementioned first embodiment.

Referring to FIG. 6, the magnetic recording/reproducing apparatus 201 according to the second embodiment is different from the magnetic recording/reproducing apparatus 101 according to the first embodiment in the respects that the apparatus 201 does not include the digital broadcast receiver 18, the MPEG decoder 19, and the AV signal output section 20 shown in FIG. 2.

In the aforementioned first embodiment, the MPEG decoder 19 is incorporated into the magnetic recording/reproducing apparatus 101, and the program-linked signal is extracted from the input signal and recorded in the CTL track of the magnetic tape 1. Further, in the aforementioned first embodiment, the program-linked signal recorded on the CTL track is read out and converted into the video signal in the tape running mode, and the image based on the video signal is superimposed on the image based on the program video signal as the output of the MPEG decoder, thereby offering the images based on the program-linked information to the viewer.

On the other hand, in the magnetic recording/reproducing apparatus 201 according to the second embodiment, the program-linked signal is obtained without using the MPEG decoder, and in the tape running mode, the program-linked signal is output from the IEEE 1394 interface 15 in order to present the image based the program-linked information to the viewer. More concretely, as shown in FIG. 5, a digital broadcast signal received at an antenna 203 is input to a digital broadcast receiver unit 202, transmitted to the magnetic recording/reproducing apparatus 201 via an IEEE 1394 interface (IF) 205, a cable and an IEEE 1394 interface 15, and then recorded therein. Further, in the tape running mode, the program-linked signal read by the CTL head 6 of the magnetic recording/reproducing apparatus 201 is input to an external device (such as a receiver circuit 206 in a TV set 204) via the IEEE 1394 interface 15, a cable, an IEEE 1394 interface 205 and the digital broadcast receiver unit 202.

Referring to FIG. 6, the program information extractor 21, in the record mode, searches for a specific data table in the MPEG data to acquire the program-linked information, generates the program-linked signal containing the program-linked information, and records the program-linked signal via the modulator 22 on the CTL track of the running magnetic tape 1. Further, the program information extractor 21, in the tape running mode, acquires the program-linked signal separated from the control signal read out from the CTL track and inputs the program-linked signal to the IEEE 1394 interface 15. Furthermore, the IEEE 1394 interface 15 receives the MPEG data, converts the MPEG data into packets based on the IEEE 1394 Standard, and transmits the packets to a device as a connection destination. Moreover, the IEEE 1394 interface 15 converts the program-linked signal received from the program information extractor 21 into packets based on the IEEE 1394 Standard and transmits the packets to the device as the connection destination.

The recording operation of the magnetic recording/reproducing apparatus 201 will next be described. Referring to FIG. 6, the magnetic recording/reproducing apparatus 201 receives the MPEG data from a device externally connected through the IEEE 1394 interface 15. The IEEE 1394 interface 15 divides the received MPEG data into packet data based on the IEEE 1394 Standard and reconstructs them into the MPEG packet data, and applies it to the D-VHS signal processor 16 and the program information extractor 21. The program information extractor 21 searches the received MPEG data for a data table having the program-linked information contained therein.

In the case of the MPEG data transmitted by broadcasting, the program-linked information is transmitted usually as stored in a data table prescribed by the broadcast standard or the like to which each broadcasting station for encoding the MPEG data should be conformed. However, there is such a case that the data table based on the broadcast standard is not present in the MPEG data, as when the MPEG data input via the IEEE 1394 interface from another recording apparatus is recorded. In such a case, the program information extractor 21 searches for a data table based on a previously-assumed broadcast standard, confirms that the corresponding data table was not detected, and then acquires and uses a recording start time and/or date and the like as the program-linked information.

The reproducing operation of the magnetic recording/reproducing apparatus 201 will next be described. In this connection, all the operations of the apparatus other than the operations of the program information extractor 21 and the IEEE 1394 interface 15 are the same as the operations of the respective constituent elements of the magnetic recording/reproducing apparatus 101 of the aforementioned first embodiment.

In the tape running mode, the program-linked signal separated from the CTL signal is input to the program information extractor 21 via the CTL head 6 and the tape phase detection/control circuit 9. The program information extractor 21 sorts the received program-linked information into a broadcast start time, a program length, a recording start date and the like or extracts individual program-linked information such as a recording start time and/or date and the like therefrom, and applies them to the IEEE 1394 interface 15.

In recent years, there are proposed various types of digital home electrical appliances based on the IEEE 1394 Standard including the HAVi (Home Audio Video interoperability) Standard. In the HAVi Standard, a device to be controlled by another device is equipped with a control module which prescribes the control procedure of the device to be controlled. The control procedure is transmitted from the device to be controlled to the control device via an IEEE 1394 interface, and therefore the control device can control the device to be controlled. In the case of the magnetic recording/reproducing apparatus based on the HAVi Standard, the program-linked information input to the IEEE 1394 interface 15 is transmitted to a control device as a connection destination in the data format based on the IEEE 1394 Standard, whereby the program-linked information can be displayed on a display device provided on the side of the control device.

In FIG. 6, the program-linked signal input to the IEEE 1394 interface 15 is transmitted in a previously determined unique data format through the use of, for example, a vendor unique command or the like based on an audio visual control (AV/C) digital interface command standard determined by the 1394 TA (Trade Association) as a Standard Organization, interpreted by the control module based on the HAVi Standard developed on a control device as its transmission destination, so that the program-linked signal can be easily displayed on a display device possessed by the control device.

As mentioned above, the magnetic recording/reproducing apparatus 201 according to the second embodiment in the record mode, acquire the program-linked signal, modulate the program-linked signal, and superpose the modulated program-linked signal on the CTL signal, record the compound signal on the CTL track, and, in the tape running mode, separates the modulated program-linked signal from the CTL signal, transmits the program-linked information to another device connected thereto via the IEEE 1394 interface, and displays it on the display device possessed by the device as its connection destination. For this reason, in the magnetic recording/reproducing apparatus 201 (or the recording and/or reproducing method employed in the apparatus), the program-linked information can be offered to the viewer not only in the normal playback mode but also in the tape running mode such as a fast forward mode, a fast rewind mode or the VISS mode regardless of the reproduction of the video signal.

Except for the above-described respects, the second embodiment is the same as the foregoing first embodiment.

Third Embodiment

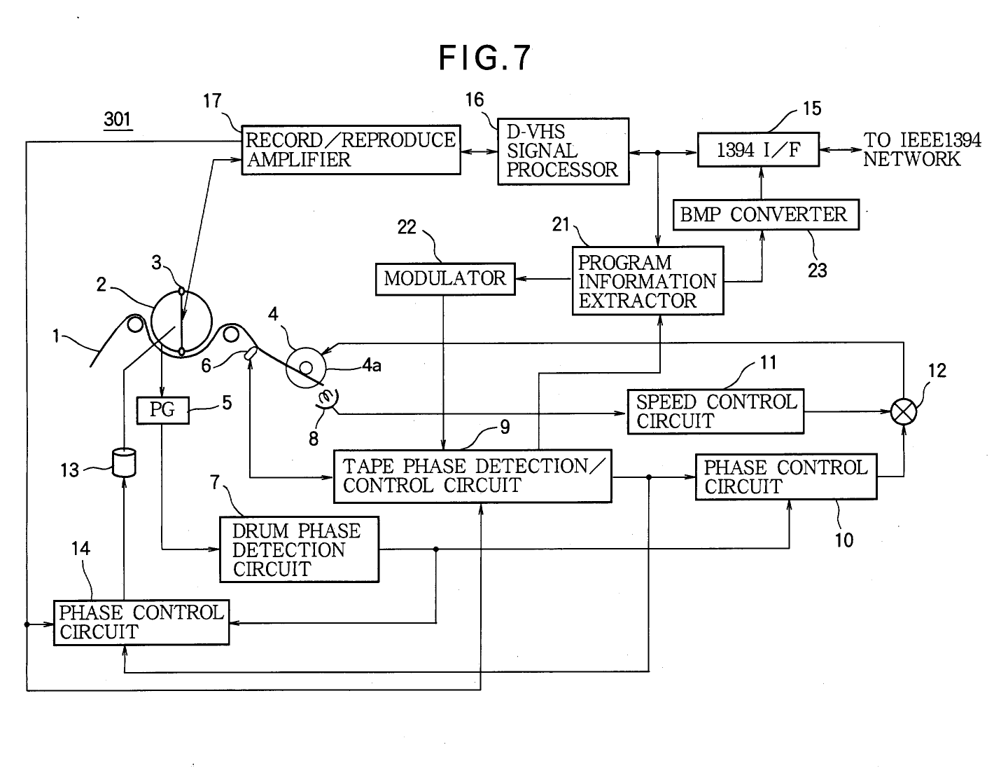

FIG. 7 is a schematic diagram showing an arrangement of the magnetic recording/reproducing apparatus 301 (i. e. an apparatus that implements a method for recording and/or reproducing signals on a magnetic tape) according to the third embodiment of the present invention. Components in FIG. 7 that are the same as or correspond to components in FIG. 2 or 6 are denoted by the same reference numerals. Furthermore, in the description of the third embodiment, reference will be made to FIGS. 3 and 4 that are used in the description of the first embodiment and FIG. 5 that is used in the description of the aforementioned second embodiment.

In the aforementioned second embodiment, in the record mode, the program-linked signal extracted from the MPEG data or the like is recorded on the CTL track of the magnetic tape so as to be superposed on the CTL signal. Further, in the aforementioned second embodiment, in the tape running mode, the program-linked information is offered to the viewer via the IEEE 1394 interface. However, the magnetic recording/reproducing apparatus 301 according to the third embodiment may be arranged so as to convert the reproduced program-linked signal into the displayable pixel data and then to offer the converted program-linked information to the viewer via the IEEE 1394 interface.

As shown in FIG. 7, the magnetic recording/reproducing apparatus 301 according to the third embodiment includes a BMP converter 23 for converting the program-linked signal received from the program-linked information extractor 21 into the bitmap (BMP) data as the displayable pixel data, and an IEEE 1394 interface 15 for the use of receiving the BMP data and transmitting therefrom the data to a connection destination device in a specific data format.

The recording operation of the magnetic recording/reproducing apparatus 301 according to the third embodiment is the same as that of the magnetic recording/reproducing apparatus 201 according to the second embodiment.

The reproducing operation of the magnetic recording/reproducing apparatus 301 will next be described. Except for the operation of the IEEE 1394 interface 15, the operations of the respective constituent elements of the magnetic recording/reproducing apparatus 301 according to the third embodiment are the same as those of the respective constituent elements of the magnetic recording/reproducing apparatus 201 according to the second embodiment.

In the tape running mode, the program-linked signal separated from the CTL signal is input to the program information extractor 21 via the CTL head 6 and the tape phase detection/control circuit 9. The program information extractor 21 sorts the received program-linked information into a broadcast start time, a program length, a recording start date and the like or extracts individual program-linked information such as a recording start time and/or date and the like therefrom, and applies them to the IEEE 1394 interface 15.

In recent years, there are provided various types of digital home electric devices based on the IEEE 1394 Standard, including the EIA (Electronic Industries Alliance) 775 Standard. The EIA 775 Standard is assumed to use a digital cable broadcasting receiver and another digital broadcasting receiver connected thereto. In the EIA 775 Standard, a control panel image can be displayed on the side of a device to be controlled and a viewer can indirectly control the device to be controlled so as to allow the device for program display and view to control the other receiver. More specifically, the device to be controlled by the other device transmits the image data about the operating panel enabling its own control operation to the control device via the IEEE 1394 interface, and displays the data in the operational environment of the control device to allow the user to indirectly control the device to be controlled. In the case of a magnetic recording/reproducing apparatus based on the EIA 775 Standard, the apparatus converts program-linked signal input to the IEEE 1394 interface 15 into the displayable pixel data prescribed in the EIA 775 Standard such as the bitmap (BMP) data and transmits the data to a control device as a connection destination in a data format conforming to the EIA 775 Standard, whereby the program-linked information can be displayed on a display device in the control device side.

As shown in FIG. 7, the program-linked information input to the IEEE 1394 interface 15 is sent to the BMP converter 23. The BMP converter 23 in turn converts the input program-linked signal to the BMP data for each classification and transmits the converted BMP data to a device as a connection destination via the IEEE 1394 interface 15.

As mentioned above, the magnetic recording/reproducing apparatus 301 according to the third embodiment in the record mode, acquire the program-linked signal, modulate the program-linked signal, and superpose the modulated program-linked signal on the CTL signal, record the compound signal on the CTL track, and, in the tape running mode, separates the modulated program-linked signal from the CTL signal, converts the program-linked signal to the BMP data for each classification of the program-linked signal, transmits the BMP data to another device connected thereto via the IEEE 1394 interface 15, and displays the BMP data on the display device possessed by the device as the connection destination. For this reason, in the magnetic recording/reproducing apparatus 301 (or the recording and/or reproducing method employed in the apparatus), the program-linked information can be offered to the viewer not only in the normal playback mode but also in the tape running mode such as a fast forward mode, a fast rewind mode or the VISS mode regardless of the reproduction of the video signal.

Except for the above-described respects, the third embodiment is the same as the foregoing first or second embodiment.

The invention being thus described, it will be obvious that the same may be varied in many ways. Such variations are not to be regarded as a departure from the spirit and scope of the invention, and all such modifications as would be obvious to one skilled in the art are intended to be included within the scope of following claims.

What is claimed is:

1. A method for recording signals on a magnetic tape, comprising:
receiving an input signal containing program data and program-linked information associated with the program data;
extracting a program-linked signal containing the program-linked information from the input signal;
modulating the program-linked signal so as to have a frequency different from any frequency within a predetermined possible range of a control signal, a frequency of the control signal being within a predetermined range corresponding to a running speed of the magnetic tape;
recording the input signal on a recording track of the magnetic tape; and
recording the control signal and the modulated program-linked signal on a control track of the magnetic tape.

2. The method according to claim 1, wherein the input signal is any of a digital signal and an analog signal.

3. The method according to claim 1, wherein the program-linked information includes at least one of a program start time, a program length, a program summary, a program name, and a broadcast channel number of the program.

4. The method according to claim 1, further comprising adding information other than information contained in the input signal to the program-linked information.

5. The method according to claim 1, wherein the frequency of the modulated program-linked signal is higher than a maximum value of possible frequencies of the control signal.

6. A magnetic tape comprising:
a recording track, on which an input signal containing program data and program-linked information associated with the program data is recorded; and
a control track, on which both a control signal of a frequency within a predetermined range corresponding to a running speed of the magnetic tape and a modulated program-linked signal are recorded;
wherein the modulated program-linked signal is obtained by extracting a program-linked signal containing the program-linked information from the input signal and modulating the program-linked signal so as to have a frequency different from any frequency within a predetermined possible range of the control signal.

7. A method for reproducing signals recorded on a magnetic tape,
the magnetic tape comprising a recording track, on which an input signal containing program data and program-linked information associated with the program data is recorded, and a control track, on which both a control signal of a frequency within a predetermined range corresponding to a running speed of the magnetic tape and a modulated program-linked signal are recorded, wherein the modulated program-linked signal is obtained by extracting a program-linked signal containing the program-linked information from the input signal and modulating the program-linked signal so as to have a frequency different from any frequency within a predetermined possible range of the control signal;
the method comprising:
reading a compound signal including the control signal and the modulated program-linked signal from the control track of the magnetic tape;
separating the modulated program-linked signal from the control signal; and
outputting a video signal based on the separated modulated program-linked signal.

8. The method according to claim 7, wherein the reading process of the compound signal is performed while the magnetic tape is running at a running speed faster than a running speed of the magnetic tape during normal playback.

9. The method according to claim 7, wherein the reading process of the compound signal is performed in an operation mode without reproducing the input signal recorded on the recording track of the magnetic tape.

10. The method according to claim 7, wherein the reading process of the compound signal is performed in an operation mode with reproducing the input signal recorded on the recording track of the magnetic tape.

11. The method according to claim 7, further comprising detecting a change of the modulated program-linked signal that has been read;
wherein the separating process of the modulated program-linked signal is performed whenever the change in the modulated program-linked signal is detected, thereby updating the video signal based on the separated modulated program-linked signal.

12. The method according to claim 7, wherein the video signal based on the separated modulated program-linked signal includes any of text data and pixel data.

13. The method according to claim 7, wherein the video signal based of the separated modulated program-linked signal is a packet signal.

14. A method for recording and reproducing signals on a magnetic tape, comprising, during a record mode,
receiving an input signal containing program data and program-linked information associated with the program data;
extracting a program-linked signal containing the program-linked information from the input signal;
modulating the program-linked signal so as to have a frequency different from any frequency within a predetermined possible range of a control signal, a frequency of the control signal being within a predetermined range corresponding to a running speed of the magnetic tape;
recording the input signal on a recording track of the magnetic tape; and
recording the control signal and the modulated program-linked signal on a control track of the magnetic tape; and
the method further comprising, during a playback mode,
reading a compound signal including the control signal and the modulated program-linked signal from the control track of the magnetic tape;
separating the modulated program-linked signal from the control signal; and
outputting a video signal based on the separated modulated program-linked signal.

15. An apparatus for recording signals on a magnetic tape, comprising:
a record head which records an input signal containing program data and program-linked information associated with the program data on a recording track of the magnetic tape;
a program information extractor which extracts a program-linked signal containing the program-linked information from the input signal;
a modulator which modulates the program-linked signal so as to have a frequency different from any frequency within a predetermined possible range of a control signal, a frequency of the control signal being within a predetermined range corresponding to a running speed of the magnetic tape; and
a control head which records the control signal and the modulated program-linked signal on a control track of the magnetic tape.

16. The apparatus according to claim 15, wherein the input signal is any of a digital signal and an analog signal.

17. The apparatus according to claim 15, wherein the program-linked information includes at least one of a program start time, a program length, a program summary, a program name, and a broadcast channel number of the program.

18. The apparatus according to claim 15, further comprising a signal processor which adds information other than information contained in the input signal to the program-linked information.

19. The apparatus according to claim 15, wherein the frequency of the modulated program-linked signal is higher than a maximum value of possible frequencies of the control signal.

20. An apparatus for reproducing signals recorded on a magnetic tape,
the magnetic tape comprising a recording track, on which an input signal containing program data and program-linked information associated with the program data is recorded, and a control track, on which both a control signal of a frequency within a predetermined range corresponding to a running speed of the magnetic tape and a modulated program-linked signal are recorded, wherein the modulated program-linked signal is obtained by extracting a program-linked signal containing the program-linked information from the input signal and modulating the program-linked signal so as to have a frequency different from any frequency within a predetermined possible range of the control signal;
the apparatus comprising:
a reproduce head which reads the input signal recorded on the recording track of the magnetic tape;
a control head which reads a compound signal including the control signal and the modulated program-linked signal from the control track of the magnetic tape;
a circuit which separates the modulated program-linked signal from the control signal; and
a signal output section which outputs a video signal based on the separated modulated program-linked signal.

21. The apparatus according to claim 20, wherein the control head reads the compound signal while the magnetic tape is running at a running speed faster than a running speed of the magnetic tape during normal playback.

22. The apparatus according to claim 20, wherein the control head reads the compound signal in an operation mode without reproducing the input signal recorded on the recording track of the magnetic tape.

23. The apparatus according to claim 20, wherein the control head reads the compound signal in an operation mode with reproducing the input signal recorded on the recording track of the magnetic tape.

24. The apparatus according to claim 20, wherein when the circuit separates the modulated program-linked signal from the control signal when the change in the modulated program-linked signal is detected, thereby updating the video signal based on the separated modulated program-linked signal.

25. The apparatus according to claim 20, wherein the video signal based on the separated modulated program-linked signal includes at least one of text data and pixel data.

26. The apparatus according to claim 20, wherein the video signal based on the separated modulated program-linked signal is a packet signal.

27. An apparatus for recording and reproducing signals on a magnetic tape, comprising:
a record/reproduce head which records an input signal containing program data and program-linked information associated with the program data on a recording track of the magnetic tape and which reads the input signal recorded on the recording track of the magnetic tape;
a program information extractor which extracts a program-linked signal containing the program-linked information from the input signal;
a modulator which modulates the program-linked signal so as to have a frequency different from any frequency within a predetermined possible range of a control signal, a frequency of the control signal being within a predetermined range corresponding to a running speed of the magnetic tape;
a control head which records the control signal and the modulated program-linked signal on the control track of the magnetic tape and which reads a compound signal including the control signal and the modulated program-linked signal from the control track of the magnetic tape;
a circuit which separates the modulated program-linked signal from the control signal; and
a signal output section which outputs a video signal based on the separated modulated program-linked signal.
